(19) United States
(12) Patent Application Publication
(10) Pub. No.: US 2026/0281865 A1
(43) Pub. Date: Sep. 17, 2026

(54) APPARATUS AND METHOD OF HANDLING CONDITIONAL HANDOVER FAILURE

(71) Applicant: GUANGDONG OPPO MOBILE TELECOMMUNICATIONS CORP., LTD., Dongguan (CN)

(72) Inventor: Xin YOU, Dongguan (CN)

(73) Assignee: GUANGDONG OPPO MOBILE TELECOMMUNICATIONS CORP., LTD., Dongguan (CN)

(21) Appl. No.: 19/676,355

(22) Filed: May 13, 2026

Related U.S. Application Data
(63) Continuation of application No. PCT/CN2024/131842, filed on Nov. 13, 2024.
(60) Provisional application No. 63/600,493, filed on Nov. 17, 2023.

(51) Int. Cl. H04W 36/36; H04W 36/00

(52) U.S. Cl. CPC H04W 36/362; H04W 36/0077

(57) ABSTRACT

A method of managing conditional reconfigurations performed by a user equipment (UE) includes performing, by a higher layer of the UE, a removal or a maintenance of conditional reconfigurations upon a completion of a mobility-related process. The completion of a mobility-related process may include one or more of the following: receiving an indication from a lower layer of the UE that an execution of a lower-layer triggered mobility (LTM) cell switch has been successfully completed, successfully completing a RACH procedure towards a target cell during an execution of a LTM cell switch, receiving the indication from the lower layer of the UE that the RACH procedure towards the target cell has been successfully completed during the execution of the LTM cell switch, executing an LTM procedure, executing a CPA, CPC, a SCPAC, or a CHO, or completing one or more of CPA, CPC, LTM, SCPAC, or CHO processes.

### CROSS-REFERENCE TO RELATED APPLICATION

The present application is a continuation of International Application No. PCT/CN2024/131842 filed on Nov. 13, 2024, which claims a priority to U.S. Patent Application No. 63/600,493 filed on Nov. 17, 2023, the contents of them are hereby incorporated by reference in their entireties.

### RELATED ART

In wireless communication systems, conditional configurations for cell addition and change are traditionally released when a user equipment (UE) completes access procedures toward a target cell. Recent advancements, such as lower-layer triggered mobility (LTM) and subsequent conditional primary secondary cell (PSCell) addition or change (SCPAC), enable dynamic cell adjustments based on lower-layer measurements and allow conditional reconfigurations without requiring full reinitialization. However, the procedures for triggering release or maintenance of these conditional configurations following LTM completion remain undefined.

Therefore, there is a need for apparatuses and methods of managing conditional reconfigurations.

### SUMMARY

The present disclosure relates to the field of communication systems.

An object of the present disclosure is to propose apparatuses and methods of managing conditional reconfigurations.

In a first aspect of the present disclosure, a method of managing conditional reconfigurations performed by a user equipment (UE), includes performing, by a higher layer of the UE, a removal or maintenance of conditional reconfigurations upon a completion of a mobility-related process.

In a second aspect of the present disclosure, a user equipment (UE) includes a memory, a transceiver, and a processor coupled to the memory and the transceiver. The UE is configured to perform the above method.

In a third aspect of the present disclosure, a non-transitory machine-readable storage medium has stored thereon instructions that, when executed by a computer, cause the computer to perform the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipments (UEs) and a base station of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a block diagram of a UE according to an embodiment of the present disclosure.

FIG. 5 is a block diagram of a UE according to an embodiment of the present disclosure.

FIG. 6 is a flowchart illustrating a method of managing conditional reconfigurations performed by a UE according to an embodiment of the present disclosure.

FIG. 7 is a block diagram of an example of a computing device according to an embodiment of the present disclosure.

FIG. 8 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), a future 5th generation (5G) system (may also be called a new radio (NR) system) or other communication systems, etc.

Optionally, a base station mentioned in the embodiments of the present application can provide a communication coverage for a specific geographic area and can communicate with a user equipment (UE) located in the coverage area. Optionally, the base station may be a gNB, a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN).

A user equipment (UE) may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved public land mobile network (PLMN), etc.

Optionally, the communication system in the embodiment of the present application may be applied to an unlicensed spectrum, where the unlicensed spectrum may also be considered as a shared spectrum; or the communication system in the embodiment of the present application may also be applied to a licensed spectrum, where the licensed spectrum can also be considered an unshared spectrum.

In legacy systems, conditional primary secondary cell (PSCell) addition (CPA) and conditional PSCell change (CPC) configurations are released when a user equipment (UE) completes a random access procedure toward a target primary cell (PCell)/PSCell. To further enhance mobility, Release 18 introduces lower-layer triggered mobility (LTM) (such as layer 1/layer 2 (L1/L2)-triggered mobility) and subsequent conditional PSCell addition or change (SCPAC). LTM is a procedure in which a base station such as a gNB receives L1 measurement reports from a UE, and, based on the L1 measurement reports, changes the UE's serving cell (e.g., PCell or PSCell) by issuing a cell switch command signaled via a medium access control (MAC) control element (CE). SCPAC is designed to enable a conditional PSCell addition or change procedure that can be executed after a PSCell change, addition, or release without requiring reconfiguration or re-initialization of the CPA/CPC setup from a network. Consequently, the UE may maintain the SCPAC configuration following a PCell/PSCell adjustment.

In some embodiments of the present disclosure, a handling of conditional configurations upon a completion of an execution of LTM and the management of LTM configurations during CPA, CPC, or SCPAC execution, are specified. This includes detailing the behavior of a UE at each protocol layer (e.g., radio resource control (RRC) layer and MAC layer) and the interactions between these layers.

In details, in some embodiments, an exemplary implementation describes how conditional configurations are handled upon the completion of LTM execution, as well as the management of LTM configurations during the execution of conditional PSCell addition (CPA), conditional PSCell change (CPC), and subsequent conditional PSCell addition or change (SCPAC). This example details the behavior of user equipment (UE) at various protocol layers, such as a radio resource control (RRC) layer and a medium access control (MAC) layer, and outlines the inter-layer interactions required to manage these configurations.

Specifically, upon receiving an indication that LTM execution is complete, the RRC layer performs actions to release or maintain conditional configurations, such as CPA, CPC, and SCPAC, stored in the UE variables. This may include removing or updating related information (e.g., cell set IDs, distributed unit (DU) IDs, or timing advance (TA) IDs) associated with these configurations. Similarly, during the execution of CPA, CPC, or SCPAC, the UE's MAC layer signals the RRC layer to adjust configurations based on the current mobility state, ensuring the UE maintains only the necessary configurations and cell set information.

Additionally, the inter-layer interactions are designed to ensure that configurations are adjusted dynamically based on the status of LTM and conditional procedures. For instance, upon the successful execution of CPA or SCPAC, the RRC layer may selectively release or retain specific configurations, such as conditional handover (CHO), depending on whether LTM is active in the main or secondary cell group. This inter-layer management minimizes reconfiguration complexity, optimizes UE resource use, and ensures smooth transitions across network cells during mobility procedures.

This exemplary approach demonstrates the effective handling of conditional configurations upon completion of LTM, CPA, CPC, or SCPAC procedures, providing enhanced mobility and network efficiency for the UE in a wireless communication system.

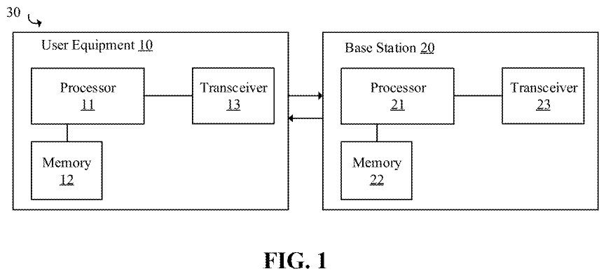

FIG. 1 illustrates that, in some embodiments, one or more user equipments (UEs) 10 and a base station (e.g., next generation NodeB (gNB) or eNB) 20 of communication in a communication network system 30 (e.g., an NR system) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured to perform a removal or maintenance of conditional reconfigurations upon a completion of a mobility-related process. This can solve issues in the prior art and other issues, and/or perform a proper behavior on a removal or a maintenance of conditional reconfigurations upon a completion of a mobility-related process.

In some embodiments, the processor 21 is condigured to initiate a command to the UE 10 to perform removal or maintenance of conditional reconfigurations upon completion of a mobility-related process. In some embodiments, the transceiver 23 is condigured to transmit an indication to the UE 10 to adjust conditional reconfigurations based on the completion of the mobility-related process. This can solve issues in the prior art and other issues, and/or perform a proper behavior on a removal or a maintenance of conditional reconfigurations upon a completion of a mobility-related process.

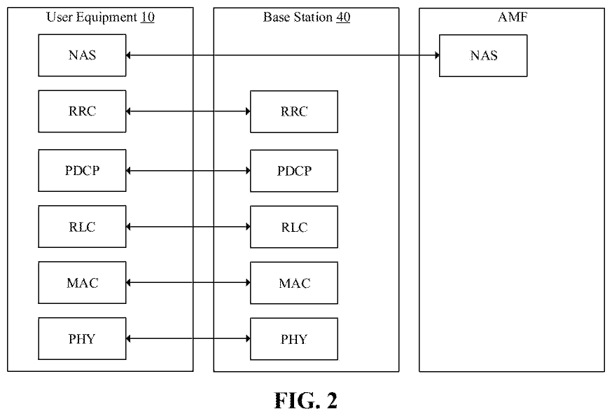

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

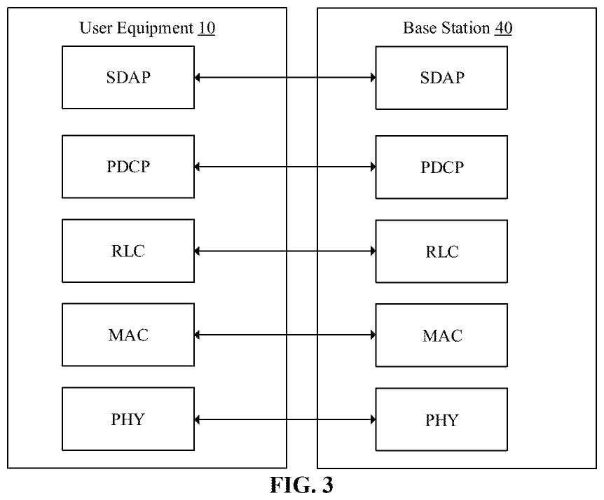

FIG. 3 illustrates an example control plane protocol stack according to an embodiment of the present disclosure. FIG. 3 illustrates that, in some embodiments, in the control plane protocol stack where PDCP, RLC, and MAC layers and PHY layer may be terminated in a UE 10 and a base station 40 (such as gNB) on a network side and perform service and functions described above. In an example, radio resource control (RRC) used to control a radio resource between the UE and a base station (such as a gNB). In an example, RRC may be terminated in a UE and the gNB on a network side. In an example, services and functions of RRC may comprise broadcast of system information related to access stratum (AS) and non-access stratum (NAS), paging initiated by 5G core network (5GC) or radio access network (RAN), establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an access and mobility management function (AMF) for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. Alternatively, the application-related information is received from the network to be provided from the AS (RRC) layer to the application layer, and when the application layer starts the data communication service, the application layer requests the information provision to the AS (RRC) layer to receive the information.

In some embodiments, a higher layer of the UE 10 is configured to perform a removal or maintenance of conditional reconfigurations upon a completion of a mobility-related process. The higher layer may be a radio resource control (RRC) layer. This can solve issues in the prior art and other issues, and/or perform a proper behavior on a removal or a maintenance of conditional reconfigurations upon a completion of a mobility-related process.

In some embodiments, the base station 40 is condigured to initiate a command to the UE 10 to perform removal or maintenance of conditional reconfigurations upon completion of a mobility-related process. In some embodiments, the base station 40 is condigured to transmit an indication to the UE to adjust conditional reconfigurations based on the completion of the mobility-related process. This can solve issues in the prior art and other issues, and/or perform a proper behavior on a removal or a maintenance of conditional reconfigurations upon a completion of a mobility-related process.

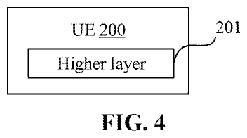

FIG. 4 illustrates an example of a UE 200 according to an embodiment of the present application. The UE 200 is configured to implement some embodiments of the disclosure. Some embodiments of the disclosure may be implemented into the UE 200 using any suitably configured hardware and/or software. The UE 200 includes a higher layer 201 configured to perform a removal or maintenance of conditional reconfigurations upon a completion of a mobility-related process. This can solve issues in the prior art and other issues, and/or perform a proper behavior on a removal or a maintenance of conditional reconfigurations upon a completion of a mobility-related process.

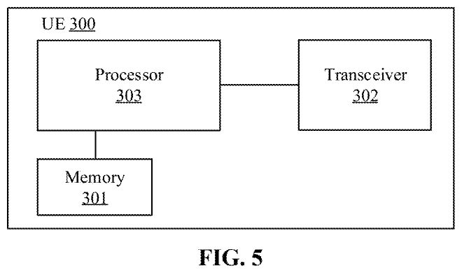

FIG. 5 illustrates an example of a UE 300 according to an embodiment of the present disclosure. The UE 300 is configured to implement some embodiments of the disclosure. Some embodiments of the disclosure may be implemented into the UE 300 using any suitably configured hardware and/or software. The UE 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art.

In some embodiments, a higher layer of the UE is configured to perform a removal or maintenance of conditional reconfigurations upon a completion of a mobility-related process. This can solve issues in the prior art and other issues, and/or perform a proper behavior on a removal or a maintenance of conditional reconfigurations upon a completion of a mobility-related process.

In some embodiments, the completion of a mobility-related process includes one or more of the following: receiving an indication from a lower layer of the UE that an execution of a lower-layer triggered mobility (LTM) cell switch has been successfully completed, successfully completing a random access channel (RACH) procedure towards a target cell during an execution of a LTM cell switch, receiving the indication from the lower layer of the UE that the RACH procedure towards the target cell has been successfully completed during the execution of the LTM cell switch, executing an LTM procedure, executing a conditional primary secondary cell (PSCell) addition or change (CPA/CPC), a subsequent conditional PSCell addition or change (SCPAC), or a conditional handover (CHO), or completing one or more of CPA, CPC, LTM, SCPAC, or CHO processes.

In some embodiments, performing, by the RRC layer of the UE, the removal or maintenance of conditional reconfigurations includes one or more of the following: removing a CPA/CPC configuration from a UE variable, if any, removing a SCPAC configuration from the UE variable, if any, removing an LTM configuration from the UE variable, if any, maintaining the SCPAC configuration within the UE variable, if any, maintaining the LTM configuration within the UE variable, if any, removing a SCPAC-related cell set information within the UE variable, if any, removing an LTM-related cell set information within the UE variable, if any, maintaining a SCPAC-related cell set information within the UE variable, if any, maintaining an LTM-related cell set information within the UE variable, if any, or maintaining or releasing a CHO configuration within the UE variable, if any.

In some embodiments, the SCPAC-related cell set information includes a security cell set identifier (ID). In some embodiments, the LTM-related cell set information includes a distributed unit (DU) information ID used to reset a layer 2 (L2) protocol stack and a UE-based timing advance (TA) information ID used to determine whether the UE-based TA is performed. In some embodiments, the UE is configured to trigger the LTM cell switch on either a main cell group (MCG) or a secondary cell group (SCG). In some embodiments, the lower layer of the UE is configured to determine the execution of the LTM cell switch to be successfully completed and transmit, to the higher layer of the UE, the indication that the execution of the LTM cell switch has been successfully completed in one or more of following cases: a reception of an uplink (UL) grant for a new transmission on a same hybrid automatic repeat request (HARQ) process used for an initial UL transmission to a target cell, a reception of a downlink (DL) assignment after the initial UL transmission to the target cell, or a successful completion of the RACH procedure towards the target cell.

In some embodiments, the lower layer of the UE is configured to indicate to the higher layer of the UE that either the execution of the LTM cell switch has been successfully completed or that the RACH procedure towards the target cell has been successfully completed during the execution of the LTM cell switch. In some embodiments, the conditional reconfigurations include one or more of the following: a CPA, a CPC, a SCPAC, or a CHO, with the CHO or a SCG, with candidate SCGs.

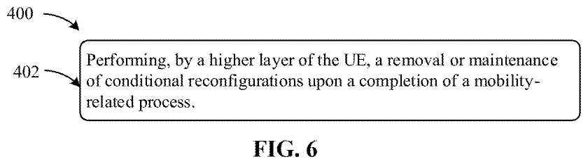

FIG. 6 is an example of a method 400 of managing conditional reconfigurations performed by a UE according to an embodiment of the present disclosure. The method 400 of managing conditional reconfigurations performed by a UE is configured to implement some embodiments of the disclosure. Some embodiments of the disclosure may be implemented into the method 400 of managing conditional reconfigurations performed by a UE using any suitably configured hardware and/or software. In some embodiments, the method 400 of managing conditional reconfigurations performed by a UE includes: an operation 402, performing, by a higher layer of the UE, a removal or maintenance of conditional reconfigurations upon a completion of a mobility-related process. This can solve issues in the prior art and other issues, and/or perform a proper behavior on a removal or a maintenance of conditional reconfigurations upon a completion of a mobility-related process.

In some embodiments, the completion of a mobility-related process includes one or more of the following receiving an indication from a lower layer of the UE that an execution of a lower-layer triggered mobility (LTM) cell switch has been successfully completed, successfully completing a random access channel (RACH) procedure towards a target cell during an execution of a LTM cell switch, receiving the indication from the lower layer of the UE that the RACH procedure towards the target cell has been successfully completed during the execution of the LTM cell switch, executing an LTM procedure, executing a conditional primary secondary cell (PSCell) addition or change (CPA/CPC), a subsequent conditional PSCell addition or change (SCPAC), or a conditional handover (CHO), or completing one or more of CPA, CPC, LTM, SCPAC, or CHO processes.

In some embodiments, performing, by the RRC layer of the UE, the removal or maintenance of conditional reconfigurations includes one or more of the following: removing a CPA/CPC configuration from a UE variable, if any, removing a SCPAC configuration from the UE variable, if any, removing an LTM configuration from the UE variable, if any, maintaining the SCPAC configuration within the UE variable, if any, maintaining the LTM configuration within the UE variable, if any, removing a SCPAC-related cell set information within the UE variable, if any, removing an LTM-related cell set information within the UE variable, if any, maintaining a SCPAC-related cell set information within the UE variable, if any, maintaining an LTM-related cell set information within the UE variable, if any, or maintaining or releasing a CHO configuration within the UE variable, if any.

In some embodiments, the SCPAC-related cell set information includes a security cell set identifier (ID). In some embodiments, the LTM-related cell set information includes a distributed unit (DU) information ID used to reset a layer 2 (L2) protocol stack and a UE-based timing advance (TA) information ID used to determine whether the UE-based TA is performed. In some embodiments, the method further includes trigging, by the UE, the LTM cell switch on either a main cell group (MCG) or a secondary cell group (SCG). In some embodiments, the method further includes determining, by the lower layer of the UE, the execution of the LTM cell switch to be successfully completed and transmit, to the higher layer of the UE, the indication that the execution of the LTM cell switch has been successfully completed in one or more of following cases: a reception of an uplink (UL) grant for a new transmission on a same hybrid automatic repeat request (HARQ) process used for an initial UL transmission to a target cell, a reception of a downlink (DL) assignment after the initial UL transmission to the target cell, or a successful completion of the RACH procedure towards the target cell.

In some embodiments, the method further includes indicating, by the lower layer of the UE, to the higher layer of the UE that either the execution of the LTM cell switch has been successfully completed or that the RACH procedure towards the target cell has been successfully completed during the execution of the LTM cell switch. In some embodiments, the conditional reconfigurations include one or more of the following: a CPA, a CPC, a SCPAC, or a CHO, with the CHO or a SCG, with candidate SCGs.

### Exemplary Technical Solutions

A radio resource control (RRC) layer of the UE performs the following actions upon: 1) receiving an indication from a lower layer (e.g., medium access control (MAC)) layer of the UE that the LTM cell switch execution has been successfully completed; or 2) successfully completing the random access channel (RACH) procedure towards the target cell during LTM cell switch execution; or 3) receiving an indication from a lower layer (e.g., MAC layer) that the RACH procedure towards the target cell has been successfully completed for LTM cell switch execution; or 4) the execution of LTM; or 5) the execution of CPA, CPC, or SCPAC; or 6) completion of the CPA, CPC, LTM, SCPAC, or CHO: a) Remove the CPA/CPC configuration from the UE variable, if any. b) Remove the SCPAC configuration from the UE variable, if any. c) Remove the LTM configuration from the UE variable, if any. d) Maintain the SCPAC configuration within the UE variable, if any. e) Maintain the LTM configuration within the UE variable, if any. f) Remove the SCPAC-related cell set information (e.g., security cell set ID) within the UE variable, if any. g) Remove the LTM-related cell set information (e.g., distributed unit (DU) information ID for resetting the L2 protocol stack, UE-based timing advance (TA) info ID to determine whether UE-based TA can be performed) within the UE variable, if any. h) Maintain the SCPAC-related cell set information (e.g., security cell set ID) within the UE variable, if any. i) Maintain the LTM-related cell set information (e.g., DU info ID for resetting the L2 protocol stack, UE-based TA info ID to determine whether UE-based TA can be performed) within the UE variable, if any. j) Maintain or release the CHO configuration within the UE variable, if any.

For example, if CPA/CPC or SCPAC is configured, release the CHO configuration after the completion of SCG LTM. Similarly, release the CHO configuration after the completion of main cell group (MCG) LTM.

The LTM cell switch can be triggered on either the main cell group (MCG) or the secondary cell group (SCG).

The MAC layer considers the LTM cell switch procedure to be successfully completed and indicates this to higher layers (e.g., RRC) under the following conditions: a) Reception of an uplink (UL) grant for new transmission on the same hybrid automatic repeat request (HARQ) process used for the initial UL transmission to the target cell. b) Reception of a downlink (DL) assignment after the initial UL transmission to the target cell. c) Successful completion of the RACH procedure towards the target cell.

The MAC layer indicates to the higher layers that either the LTM cell switch execution has been successfully completed or the RACH procedure towards the target cell has been successfully completed for LTM cell switch execution.

The radio resource control (RRC) layer manages the removal or maintenance of conditional reconfigurations in response to specific indicators from lower layers. This includes signals that the LTM cell switch has been successfully completed or that the RACH procedure to the target cell has finished during LTM execution. The conditional reconfigurations covered include conditional PSCell addition (CPA), conditional PSCell change (CPC), subsequent conditional PSCell addition or change (SCPAC), and conditional handover (CHO), as well as CHO configurations with secondary cell groups (SCG) or candidate SCGs.

The radio resource control (RRC) layer in the user equipment (UE) manages conditional configurations upon completion of mobility-related processes, including lower-layer triggered mobility (LTM) cell switch, random access channel (RACH) procedures, and conditional handovers. This management involves selectively removing or maintaining configurations and associated cell information, such as CPA/CPC, SCPAC, and LTM data. The Medium Access Control (MAC) layer supports this process by indicating successful LTM or RACH completions to the higher layers under specific conditions, including uplink and downlink receptions or RACH procedure success. These interactions ensure efficient handling of mobility events, dynamically adapting UE configurations for optimized performance across cell groups.

In the proposed solution, in some embodiments, a method is implemented in the user equipment (UE) to manage conditional configurations efficiently upon completion of LTM execution. When the LTM process is completed, the RRC layer within the UE assesses existing conditional configurations, such as conditional PSCell addition (CPA), conditional PSCell change (CPC), and subsequent conditional PSCell addition or change (SCPAC). The RRC layer then determines whether each configuration can be removed or maintained based on predefined conditions and the current network environment.

For instance, upon receiving an indication from the medium access control (MAC) layer signaling the successful completion of an LTM cell switch, the RRC layer may remove obsolete CPA/CPC configurations while retaining SCPAC configurations relevant to the current serving cell. This process also involves managing related cell information, such as security cell set IDs and Distributed Unit (DU) information identifiers for resetting the Layer 2 protocol stack.

In scenarios where conditional handover (CHO) is involved, the solution enables the UE to release or maintain the CHO configuration depending on the status of LTM completion in either the main cell group (MCG) or secondary cell group (SCG). This selective removal or maintenance of configurations minimizes reconfiguration overhead, optimizes resource utilization, and ensures the UE is prepared for seamless mobility in subsequent network scenarios. This example demonstrates how the proposed solution allows the UE to efficiently adapt its conditional configurations, providing improved performance and network efficiency.

Commercial interests for some embodiments are as follows. 1. Solve issues in the prior art and other issues. 2. Perform a proper behavior on a removal or a maintenance of conditional reconfigurations upon a completion of a mobility-related process. 3. Maintain service continuity. 4. Provide a good communication performance. 5. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of wireless communication are considered for standardizing.

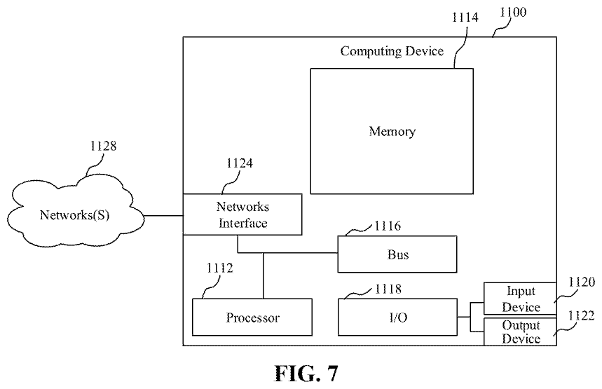

FIG. 7 is an example of a computing device 1100 according to an embodiment of the present disclosure. Any suitable computing device can be used for performing the operations described herein. For example, FIG. 7 illustrates an example of the computing device 1100 that can implement some embodiments of FIG. 1 to FIG. 6 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 1 to FIG. 6. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

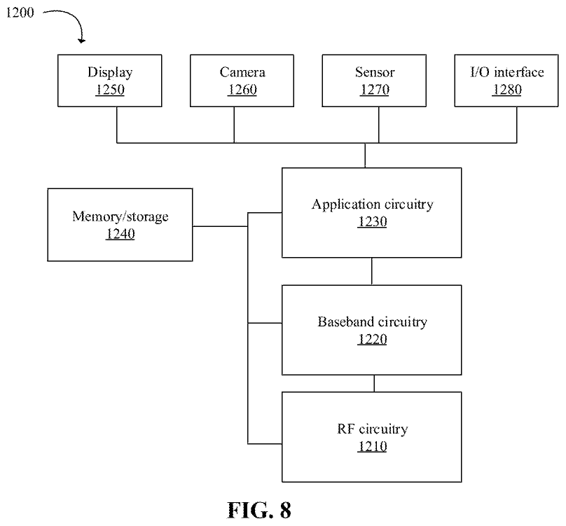

FIG. 8 is a block diagram of an example of a communication system 1200 according to an embodiment of the present disclosure. Embodiments described herein may be implemented into the communication system 1200 using any suitably configured hardware and/or software. FIG. 8 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 1 to FIG. 6. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 1 to FIG. 6 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and operations described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the operations disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method of managing conditional reconfigurations performed by a user equipment (UE), comprising:
performing, by a higher layer of the UE, a removal or a maintenance of conditional reconfigurations upon a completion of a mobility-related process.

2. The method of claim 1, wherein the completion of a mobility-related process comprises one or more of the following:
receiving an indication from a lower layer of the UE that an execution of a lower-layer triggered mobility (LTM) cell switch has been successfully completed;
successfully completing a random access channel (RACH) procedure towards a target cell during an execution of a LTM cell switch;
receiving the indication from the lower layer of the UE that the RACH procedure towards the target cell has been successfully completed during the execution of the LTM cell switch;
executing an LTM procedure;
executing a conditional primary secondary cell (PSCell) addition or change (CPA/CPC), a subsequent conditional PSCell addition or change (SCPAC), or a conditional handover (CHO); or
completing one or more of CPA, CPC, LTM, SCPAC, or CHO processes.

3. The method of claim 1, wherein performing, by the higher layer of the UE, the removal or maintenance of conditional reconfigurations comprises one or more of the following:
removing a CPA/CPC configuration from a UE variable, if any;
removing a SCPAC configuration from the UE variable, if any;
removing an LTM configuration from the UE variable, if any;
maintaining the SCPAC configuration within the UE variable, if any;
maintaining the LTM configuration within the UE variable, if any;
removing a SCPAC-related cell set information within the UE variable, if any;
removing an LTM-related cell set information within the UE variable, if any;
maintaining a SCPAC-related cell set information within the UE variable, if any;
maintaining an LTM-related cell set information within the UE variable, if any; or
maintaining or releasing a CHO configuration within the UE variable, if any.

4. The method of claim 3, wherein the SCPAC-related cell set information comprises a security cell set identifier (ID).

5. The method of claim 3, wherein the LTM-related cell set information comprises a distributed unit (DU) information ID used to reset a layer 2 (L2) protocol stack and a UE-based timing advance (TA) information ID used to determine whether the UE-based TA is performed.

6. The method of claim 2, further comprising trigging, by the UE, the LTM cell switch on either a main cell group (MCG) or a secondary cell group (SCG).

7. The method of claim 2, further comprising determining, by the lower layer of the UE, the execution of the LTM cell switch to be successfully completed and transmit, to the higher layer of the UE, the indication that the execution of the LTM cell switch has been successfully completed in one or more of following cases:
a reception of an uplink (UL) grant for a new transmission on a same hybrid automatic repeat request (HARQ) process used for an initial UL transmission to a target cell;
a reception of a downlink (DL) assignment after the initial UL transmission to the target cell; or
a successful completion of the RACH procedure towards the target cell.

8. The method of claim 2, further comprising indicating, by the lower layer of the UE, to the higher layer of the UE that either the execution of the LTM cell switch has been successfully completed or that the RACH procedure towards the target cell has been successfully completed during the execution of the LTM cell switch.

9. The method of claim 1, wherein the conditional reconfigurations comprise one or more of the following: a CPA, a CPC, a SCPAC, or a CHO, with the CHO or a SCG, with candidate SCGs.

10. A user equipment (UE), comprising:
a memory for storing instructions; and
a processor coupled to the memory;
wherein the processor is configured to execute the instructions from the memory to cause a higher layer of the UE to perform a removal or a maintenance of conditional reconfigurations upon a completion of a mobility-related process.

11. The UE of claim 10, wherein the completion of a mobility-related process comprises one or more of the following:
receiving an indication from a lower layer of the UE that an execution of a lower-layer triggered mobility (LTM) cell switch has been successfully completed;
successfully completing a random access channel (RACH) procedure towards a target cell during an execution of a LTM cell switch;
receiving the indication from the lower layer of the UE that the RACH procedure towards the target cell has been successfully completed during the execution of the LTM cell switch;
executing an LTM procedure;
executing a conditional primary secondary cell (PSCell) addition or change (CPA/CPC), a subsequent conditional PSCell addition or change (SCPAC), or a conditional handover (CHO); or
completing one or more of CPA, CPC, LTM, SCPAC, or CHO processes.

12. The UE of claim 10, wherein to perform the removal or maintenance of conditional reconfigurations, the processor is configured to execute the instructions from the memory to cause the higher layer of the UE to perform one or more of the following:
removing a CPA/CPC configuration from a UE variable, if any;
removing a SCPAC configuration from the UE variable, if any;
removing an LTM configuration from the UE variable, if any;
maintaining the SCPAC configuration within the UE variable, if any;
maintaining the LTM configuration within the UE variable, if any;
removing a SCPAC-related cell set information within the UE variable, if any;
removing an LTM-related cell set information within the UE variable, if any;
maintaining a SCPAC-related cell set information within the UE variable, if any;
maintaining an LTM-related cell set information within the UE variable, if any; or
maintaining or releasing a CHO configuration within the UE variable, if any.

13. The UE of claim 12, wherein the SCPAC-related cell set information comprises a security cell set identifier (ID).

14. The UE of claim 12, wherein the LTM-related cell set information comprises a distributed unit (DU) information ID used to reset a layer 2 (L2) protocol stack and a UE-based timing advance (TA) information ID used to determine whether the UE-based TA is performed.

15. The UE of claim 11, wherein the UE is configured to trigger the LTM cell switch on either a main cell group (MCG) or a secondary cell group (SCG).

16. The UE of claim 11, wherein the higher layer of the UE is configured to receive the indication that the execution of the LTM cell switch has been successfully completed from the lower layer of the UE, the successful completion of the execution of the LTM cell switch is determined by the lower layer of the UE in one or more of following cases:
a reception of an uplink (UL) grant for a new transmission on a same hybrid automatic repeat request (HARQ) process used for an initial UL transmission to a target cell;
a reception of a downlink (DL) assignment after the initial UL transmission to the target cell; or
a successful completion of the RACH procedure towards the target cell.

17. The UE of claim 11, wherein the higher layer of the UE is configured to receive an indication from the higher layer of the UE that either the execution of the LTM cell switch has been successfully completed or that the RACH procedure towards the target cell has been successfully completed during the execution of the LTM cell switch.

18. The UE of claim 10, wherein the conditional reconfigurations comprise one or more of the following: a CPA, a CPC, a SCPAC, or a CHO, with the CHO or a SCG, with candidate SCGs.

19. A chip, including:
a processor, configured to call and run a computer program stored in a memory, to cause a device in which the chip is installed to perform, via a higher layer of the device, a removal or a maintenance of conditional reconfigurations upon a completion of a mobility-related process.

20. The chip of claim 19, wherein the processor is configured to call and run a computer program stored in a memory, to cause a device in which the chip is installed to perform, via the higher layer of the device, one or more of the following:
removing a CPA/CPC configuration from a UE variable, if any;
removing a SCPAC configuration from the UE variable, if any;
removing an LTM configuration from the UE variable, if any;
maintaining the SCPAC configuration within the UE variable, if any;
maintaining the LTM configuration within the UE variable, if any;
removing a SCPAC-related cell set information within the UE variable, if any;
removing an LTM-related cell set information within the UE variable, if any;
maintaining a SCPAC-related cell set information within the UE variable, if any;
maintaining an LTM-related cell set information within the UE variable, if any; or
maintaining or releasing a CHO configuration within the UE variable, if any.
